(19) United States
(12) Patent Application Publication
(10) Pub. No.: US 2025/0351783 A1
(43) Pub. Date: Nov. 20, 2025

(54) ROOT BARRIER

(71) Applicants: TOM SMITH, ANAHEIM, CA (US); LOGAN SMITH, ANAHEIM, CA (US)

(72) Inventors: TOM SMITH, ANAHEIM, CA (US); LOGAN SMITH, ANAHEIM, CA (US)

(21) Appl. No.: 18/665,230

(22) Filed: May 15, 2024

(51) Int. Cl. A01G 13/02

(52) U.S. Cl. CPC A01G 13/27

(57) ABSTRACT

The root barrier has an inner panel with an inner panel middle warp. An inner panel lower edge and an inner panel upper edge formed on the inner panel. An inner panel right edge, and an inner panel left edge are formed on the inner panel. An inner panel right rib are formed on the inner panel right edge and an inner panel left rib is formed on the inner panel left edge. The inner panel right rib is formed as a first pinch rib and the inner panel left rib is formed as a second pinch rib. The first pinch rib and the second pinch rib are both configured to connect with an outer panel by nesting the pinch ribs that pinch to each other.

The present invention has no priority claim.

### TECHNICAL FIELD

The present disclosure relates to root barriers.

### BACKGROUND

Traditionally, root barriers have been made of 100% high density polyethylene which makes the root barriers fairly rigid and for long-lasting robust capability. Unfortunately, these root barriers lift out of the ground and are not barefoot safe.

### SUMMARY OF THE INVENTION

The following design is to keep the root barrier panels from sliding up out of the ground. The base of the panel will flare, making a parachute effect or land lock all made possible due to the flexible material, the product is made from roughly half low-density polyethylene and half high-density polyethylene. Soil will add friction on the panel and prevent it from sliding upward, as well as locking it in place, as a root grows bigger due to the spring flexible nature of the panel interaction.

The top edge of the root barrier is designed thin to not be so visible from above grade, unlike traditional root barrier the thin polyethylene edge is made from a material that is flexible and is able to bend and fold to be barefoot safe. A top safety edge is less visible on landscaping but is still barefoot safe.

The inverted ribs are designed to have two different functions with one side designed to catch the root and keep the root from sliding sideways along the panel, directing the root either up or down. The inverted portion of the rib on the other side is designed to stop the root and direct it either up or down, this way, the material can be planted with either direction toward the root ball and successfully direct the roots to prevent root girdling on newly planted shrubs or trees

The new rib material is designed to lock one rib into the other, and is being held by friction. The soil is packed tightly on both sides of the barrier, locking the product panel, the panel, an anti-friction movement product the tighter the soil is packed the tighter, the panels are locked together, making them inseparable and preventing any areas for roots to penetrate the product. The root barrier panels are made from a unique blend of polyethylene. This allows this material to be very flexible, but yet not crack or tear from the stress being applied to it from the existing trees we are made from a 50% post industrial low density polyethylene, and a 50% High density post industrial polyethylene with 3% carbon mix.

The hydraulic folding application of this machine allows two vertical ribs to be placed within the machine at the same time while the base is moved upward to lock material in place after material has been heated to approximately 290° the machine will fold downward, and the carrier will move forward, approximately 6 inches to allow the set up for the next set of ribs to be applied all done while locking the material in place. The Hydraulic folding is being cooled through a chilled water injection throughout aluminum blocks. A carrier cam moves backwards to set up for the next fold on material. The vertical ribs are the important factors that both sides of the material can be used to lock ribs to roots. The angles on these ribs should be 40 to 90°. The material is a multipurpose, material, a water barrier and a root barrier, all in one unique design with leaf spring soil friction locks.

The root barrier has an inner panel with an inner panel middle warp. An inner panel lower edge and an inner panel upper edge formed on the inner panel. An inner panel right edge, and an inner panel left edge are formed on the inner panel. An inner panel right rib are formed on the inner panel right edge and an inner panel left rib is formed on the inner panel left edge. The inner panel right rib is formed as a first pinch rib and the inner panel left rib is formed as a second pinch rib. The first pinch rib and the second pinch rib are both configured to connect with an outer panel by nesting the pinch ribs that pinch to each other. The outer panel and the inner panel form a panel overlap. A parallel portion is formed along the panel overlap. The parallel portion has a panel gap. The inner panel right rib forms a first inner pinch retainer. The panel left rib forms a second inner pinch retainer. The first inner pinch retainer is formed as a first notch and groove connector. The second inner pinch retainer is formed as a second notch and groove connector.

The inner panel is flexible and acts as a leaf spring. The inner panel middle warp is resilient and can be flattened along the panel overlap when compressed together in an installed mode. The inner panel is formed with a flexible panel lower edge. The inner panel is configured to deform when a root grows under the inner panel. The inner panel is formed of at least 40% low-density polyethylene by weight, 40% high density polyethylene by weight, and at least 2% carbon. The inner panel right rib is V-shaped and the panel left rib is also V-shaped.

The outer panel also has an outer panel middle warp. An outer panel lower edge and an outer panel upper edge are formed on the outer panel. An outer panel right edge, and an outer panel left edge are formed on the outer panel. The outer panel right rib is formed on the outer panel right edge and the outer panel left rib is formed on the outer panel left edge. The outer panel right rib is formed as a first pinch rib and the outer panel left rib is formed as a second pinch rib. The inner panel is flexible and acts as a leaf spring. The inner panel middle warp is resilient and can be flattened along the panel overlap when compressed together in an installed mode.

The inner panel is formed with a folding machine which has a first forming bar and a second forming bar. The second forming bar is mounted after the first forming bar at a set distance from the first forming bar. A first heater is mounted to the first forming bar and a second heater mounted to the second forming bar. A first swivel arm forms the first pinch rib at a first forming gap and a second swivel arm forms the second pinch rib at a second forming gap. The first heater and the second heater heat a material feed to form a middle warp on the panel between the inner panel right rib and the inner panel left rib.

### BRIEF DESCRIPTION OF THE DRAWINGS

FIG. 1 is a diagram showing a panel of the present invention.

FIG. 2 is a diagram showing an inside panel of the present invention.

FIG. 3 is a diagram showing an outer panel connecting with an inner panel.

FIG. 4 is a diagram showing the folding machine.

FIG. 5 is a diagram showing a side view of the folding machine.

The following call out list of elements can be a useful guide in referencing the element numbers of the drawings.
20 panel
21 panel upper edge
22 panel lower edge
23 panel right edge
24 panel left edge
25 flexible bottom portion
26 deformation area
27 panel right rib
28 panel left rib
30 adjacent panel
31 out panel
32 inner panel
33 panel overlap
34 first notch and groove connector
35 second notch and groove connector
36 first pinch retainer
37 second pinch retainer
38 parallel portion
39 end or roll
40 rib form frame
41 first linear actuator
42 second linear actuator
43 first forming bar
44 second forming bar
45 first swivel arm
46 second swivel arm
47 first forming gap
49 material feed
51 front base
52 rear base
53 first hinge
54 second hinge
55 first heater blade
56 second heater blade
57 first heater
58 second heater
61 first pinch rib
62 second pinch rib
63 material bend
88 middle warp
89 panel gap
128 tree root

### DETAILED DESCRIPTION OF THE EMBODIMENTS

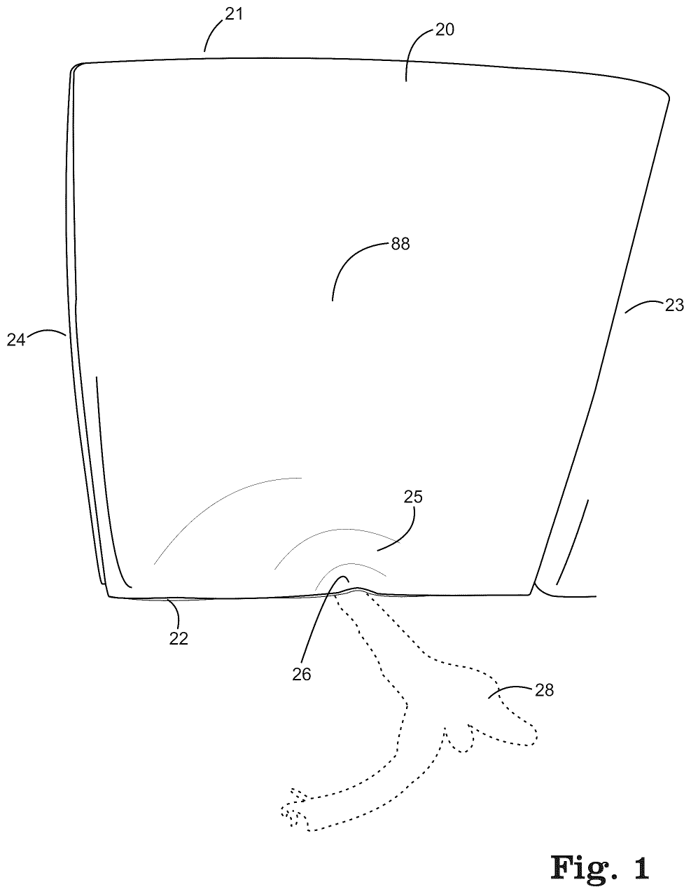

As shown in FIG. 1, the following root barrier is designed to retain itself from sliding up out of the ground over time. As a root grows underneath the root barrier, a bottom edge of the panel will flare and deform which acts as a parachute or lock and thus anchor the root barrier to the ground. The root barrier is made of a flexible material such as a plastic sheet such as the medium density polyethylene. The material procured is a specialty blended material of Low-Density and High-Density Polyethylene. The typical material used for root barriers can be softened so that the root barriers have a flexible bottom portion 25. The flexible bottom portion 25 allows a deformation area 26 when a plant root or tree root 128 grows underneath the root barrier. The panel 20 of the repair includes a panel upper edge 21 that may be exposed and not buried. The panel 20 also includes a panel right edge 23 and the panel left edge 24 which can be continuous with other panels to be joint into a sheet or roll. The panel lower edge 22 of the panel 20 has the flexible bottom portion 25. Preferably, a middle warp 88 is also introduced such that the panel 20 is not flat, but rather has an undulation. The middle warp 88 travels from the panel right edge 23 to the panel left edge 24. The panel right edge 23 and the panel left edge 24 both have a slight bend to it given by the middle warp 88. The slide bend on the panel right edge and the panel left edge allow the panels to lock up to each other when necessary.

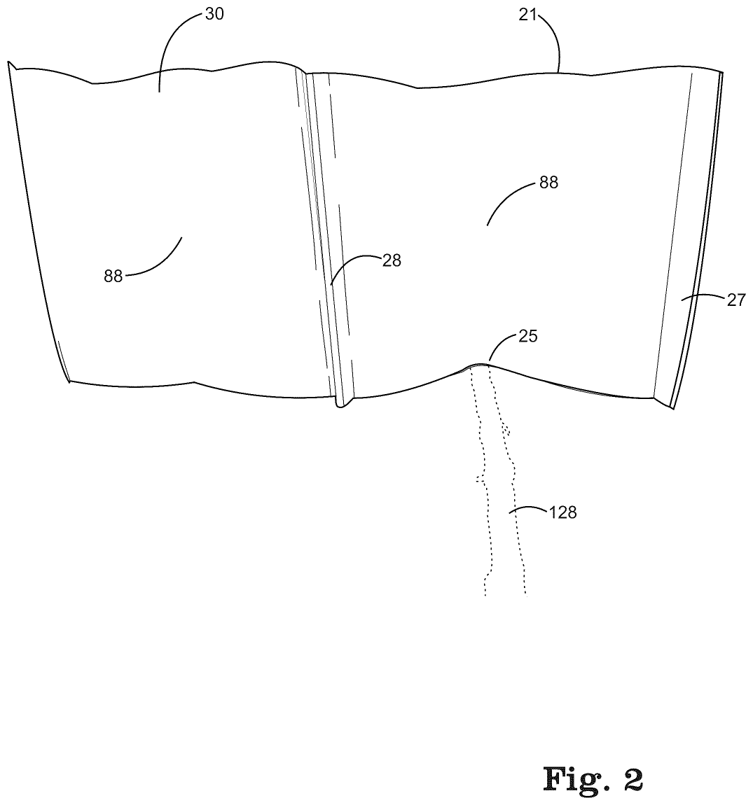

As seen in FIG. 2, the panel upper edge 21 is also undulating, the undulation of which is exaggerated as shown in the figure. The adjacent panel 30 also has a middle warp 88. The middle warps 88 are flexible and behave as springs for locking the panel into the ground. When the tree root 128 grows under the flexible soft portion 25, the deformation at the flexible soft portion 25 can be continued to the middle warp 88 such that the panel right rib 27 and the panel 28 lock to the ground. The flexible soft portion 25 has a deformation when a tree root 128 grows under it. The deformation can be concave or convex and the deformation of the middle warp can also be concave or convex. Typically, the flexible bottom portion 25 would have a concave deformation and the middle warp 88 would also have a concave deformation. The concave deformations act as a leaf spring such that the panel acts as a leaf spring for locking to the ground.

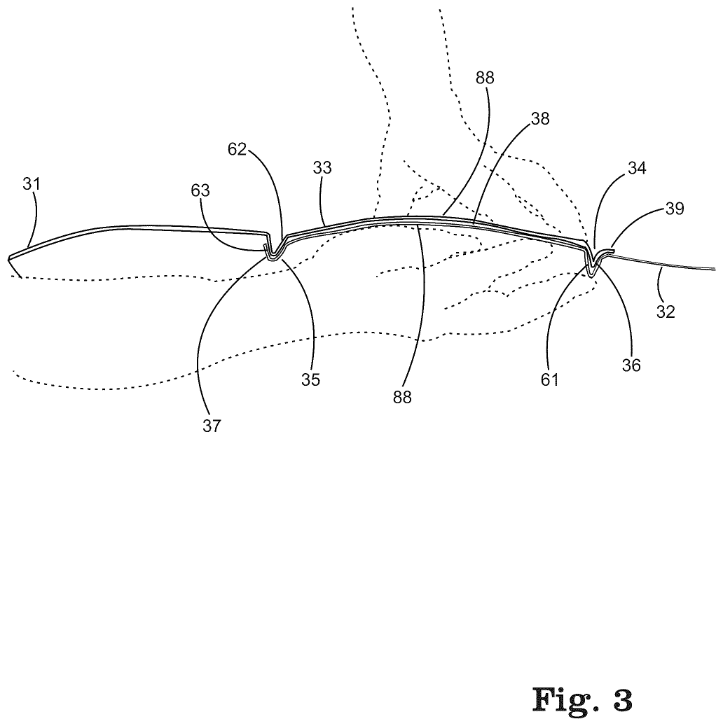

As seen in FIG. 3, the panels lock together as the undulations form a parallel portion 38 having a middle warp 88 on the panel overlap portion 33. The panel overlap portion has a first pinch retainer 36 and a second pinch retainer and 37. The first pinch retainer 36 uses the groove of the inner panel 32 such as the first notch and groove connector 34 and the second notch and groove connector 35. The panel right rib 27 and the panel left rib 28 of the outer panel 31 and the inner panel 32 locked together to form the first notch include connector 34 and the second notch and groove connector 35. As the user pushes the panels together, the middle warps 88 of each of the panels create a panel gap 89 in between the panels. The leaf spring nature of the panel gaps 89 creates a locking force at the panel right ribs 27 and the panel left ribs 28 such that they lock together with a spring force when buried.

Undulations will add friction on the panels and prevent them from sliding upward since they are biasing away from each other such as to wedge themselves in the ground or soil. The undulations are uneven, and become more parallel when dirt is filled on both sides to push them together. After the panels are locked in place, as a root grows bigger, the root deforms the lower flexible portion which further locks the panel in place. During an unburied portion of the assembly, a user pushes the V shaped ribs into each other to build a temporary structure where the uneven right panel ribs and left panel ribs have spring force due to the middle warp 88. The warp spring force provides a retaining force that holds the ribs to each other. After the barrier is buried in the ground, the panel gap 89 is closed which further provides a spring force where the outer panel 31 pushes outwardly and the inner panel 32 pushes inwardly so as to wedge the parallel portion 38 firmly. The material bend 63 also acts as a spring which locks the panels together. The panel gap 89 is exaggerated for clarification. The parallel portion 38 is generally curved, but appears fairly straight and parallel when seen in a close-up view.

The top edge of the root barrier can be thin to not be so visible from above grade. The root barrier is thinner than 80 mil and preferably less than 65 mil thick. A thin polyethylene edge is made from a material that is very flexible and can bend and fold to prevent damage to feet. The top portion remains flexible so that the top safety edge is not seen on the landscaping. As the top edge is flexible, it is step safe if users step on it with bare feet. A variety of methods can be used to soften and make flexible the existing root barrier material. Having a flexible material creates a spring flex that provides both a safety feature at the top edge, a retaining feature at the bottom edge and a retaining feature in the middle of the panel.

The panel also has inverted ribs are designed to have two different effects on one side it is designed to catch the root and keep the route from sliding sideways along the panel, directing the route either up or down. The inverted portion of the rib on the other side is designed to stop the root and direct it either up or down. This way the material can be planted with either direction toward the root ball and successfully direct the roots to prevent root gurgling on newly planted shrubs or trees. The inverted ribs connect with each other when pressed together. The new rib material is designed to lock one rib into the other, and is being held by friction and tension. The soil is packed tightly on both sides of the barrier, locking the product panel, the panel, an anti-friction movement product. The soil pack tightens the connection between the panels when the panels are locked together. This makes the panels inseparable and prevents any areas for roots to penetrate the product.

To provide the flexible material that allows the connection of the ribs and warp connection, the root barrier panels are preferably made from a unique blend of polyethylene. The best mode known to date allows the material to be a flexible, but yet not crack or tear from the stress being applied to it from existing trees, which is a 50% post industrial low density polyethylene, and a 50% high density post industrial polyethylene with 3% carbon mix. When other material is being mixed in, the low-density polyethylene is preferably at least 40%, and the high density polyethylene is at least 40%, and the carbon mix is at least 2%. The carbon mix can be a graphite carbon black which can be helpful for ultraviolet resistance.

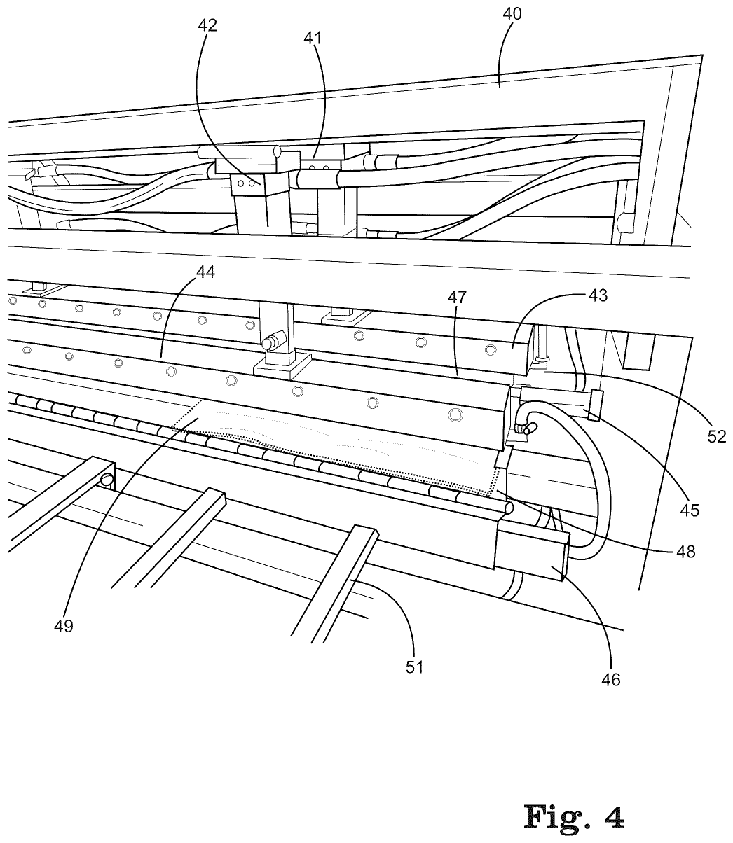

As seen in FIG. 4, the hydraulic folding application of this machine allows two vertical ribs to be placed within the machine at the same time while the base is moved upward to lock material in place after material has been heated to approximately 290°. The machine will fold downward, and the carrier will move forward, approximately 6 inches to allow the set up for the next set of ribs to be applied. This is all done while locking the material in place as the carrier moves backwards to set up for the next fold of material. The vertical ribs are formed to connect with each other when overlapped such that both sides of the material can be used to lock the ribs with each other. The angles on the ribs should be 40° to 90°. The material can be provided in a roll and can be used for multiple purposes including a water barrier and a root barrier, with soil friction locks.

The folding machine includes a rib forming frame 40 with a first linear actuator 41 and a second linear actuator 42. The material feed 49 runs through the folding machine. The folding machine has a first forming bar 43 and a second forming bar 44. The first forming bar 43 pushes material into a first forming 47. The second forming bar 44 pushes material into a second forming 48. The first forming bar 43 and the second forming bar 44 have heaters such as electrical resistance heaters that heat the material feed 49 and create undulations in the material so that the material is not perfectly flat and slick. The front base 51 receives the material feed 49, and the rear base 52 supports the rear portion of the material feed 49. The ribs are created with a first swivel arm 45 making a first fold and the second swivel arm 46 making a second fold.

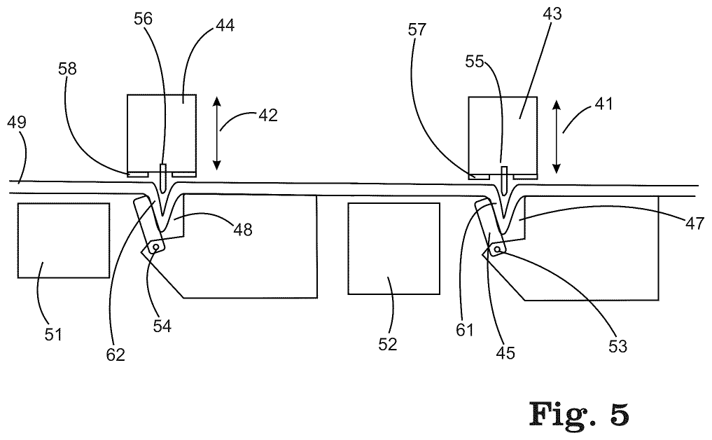

As seen in FIG. 5, the material feed 49 travels to the left. The first heater 57 is spaced apart from the second heater 58. The first heater 57 heats the material under the first heater blade 55 and the second heater heats the material under the second heater blade 56. The first heater blade 55 presses the material down to form a first pinch rib 61 and the second heater blade 56 presses material down to form a second pinch rib 62. The first linear actuator 41 actuates and raises and lowers the first heater blade 55, and the second linear actuator 42 raises and lowers the second heater blade 56. The first swivel arm 45 presses the first pinch rib in a first forming gap 47. The second swivel arm 46 presses the second pinch rib 62 in a second forming gap 48. The first forming bar 43 and the second forming bar 44 are spaced apart from each other to define a panel section on the material feed 49. The rear base 52 and the front face 51 hold the material feed 49 as the material feed slides forward. The first swivel arm 45 is mounted on a first hinge 53 and the second swivel arm 46 is mounted on a second hinge 54.

After the material feed is transformed into root barrier panels, the root barrier panels are rolled for storage and later brought to the job site. At the jobsite, a user can cut the root barrier panels and press the panels together to connect them. The panel connection method does not require tools or connectors such as staples, bolts or the like. The panel connection method only requires a blade for cutting the panel. The root barrier panels can circumscribe a tree or young planting for example. Initially, roots are not touching the root barrier panels. In the installed mode, the panels are pressed together and have a spring tension that expands outwardly to try to create a gap. The panels are not congruent, such that the middle warp of each panel does not align exactly. Thus, as the panels are formed as springs, the springs press outwardly to form a gap. Panel material is preferably an A-46 black postindustrial polyethylene regrind mix in the range of 0.960 g/cm³ with a melt flow of 0.3 g/10 min and a hardness of 95R.

1. A root barrier comprising:
a. an inner panel, wherein the inner panel has an inner panel middle warp;
b. an inner panel lower edge and an inner panel upper edge formed on the inner panel;
c. an inner panel right edge, and an inner panel left edge formed on the inner panel;
d. an inner panel right rib formed on the inner panel right edge and an inner panel left rib formed on the inner panel left edge, wherein the inner panel right rib is formed as a first pinch rib and wherein the inner panel left rib is formed as a second pinch rib, wherein the first pinch rib and the second pinch rib are both configured to connect with an outer panel, wherein the outer panel and the inner panel form a panel overlap; and
e. a parallel portion formed along the panel overlap, wherein the parallel portion has a panel gap, wherein the inner panel right rib forms a first inner pinch retainer, and wherein the panel left rib forms a second inner pinch retainer, wherein the first inner pinch retainer is formed as a first notch and groove connector, wherein the second inner pinch retainer is formed as a second notch and groove connector.

2. The root barrier of claim 1, wherein the inner panel is flexible and acts as a leaf spring, wherein the inner panel middle warp is resilient and can be flattened along the panel overlap when compressed together in an installed mode.

3. The root barrier of claim 1, wherein the inner panel is formed with a flexible panel lower edge.

4. The root barrier of claim 1, wherein the inner panel is configured to deform when a root grows under the inner panel.

5. The root barrier of claim 1, wherein the inner panel is formed of at least 40% low-density polyethylene by weight, 40% high density polyethylene by weight, and at least 2% carbon.

6. The root barrier of claim 1, wherein the inner panel right rib is V-shaped and the panel left rib is also V-shaped.

7. The root barrier of claim 1, wherein the outer panel further comprises:
a. an outer panel middle warp;
b. an outer panel lower edge and an outer panel upper edge formed on the outer panel;
c. an outer panel right edge, and an outer panel left edge formed on the outer panel; and
d. an outer panel right rib formed on the outer panel right edge and an outer panel left rib formed on the outer panel left edge, wherein the outer panel right rib is formed as a first pinch rib and wherein the outer panel left rib is formed as a second pinch rib.

8. The root barrier of claim 7, wherein the inner panel is flexible and acts as a leaf spring, wherein the inner panel middle warp is resilient and can be flattened along the panel overlap when compressed together in an installed mode.

9. The root barrier of claim 7, wherein the inner panel is formed with a flexible panel lower edge.

10. The root barrier of claim 7, wherein the inner panel is configured to deform when a root grows under the inner panel.

11. The root barrier of claim 7, wherein the inner panel is formed of at least 40% low-density polyethylene by weight, 40% high density polyethylene by weight, and at least 2% carbon.

12. The root barrier of claim 7, wherein the inner panel right rib is V-shaped and the panel left rib is also V-shaped.

13. The root barrier of claim 7, wherein the inner panel is formed with a folding machine, wherein the folding machine comprises:
a. a first forming bar;
b. a second forming bar, wherein the second forming bar is mounted after the first forming bar, wherein the second forming bar is mounted at a set distance from the first forming bar;
c. a first heater mounted to the first forming bar;
d. a second heater mounted to the second forming bar;
e. a first swivel arm, wherein the first swivel arm forms the first pinch rib at a first forming gap; and
f. a second swivel arm, wherein the second swivel arm forms the second pinch rib at a second forming gap.

14. The root barrier of claim 13, wherein the first heater and the second heater heat a material feed to form a middle warp on the panel between the inner panel right rib and the inner panel left rib.

15. The root barrier of claim 13, wherein the inner panel is flexible and acts as a leaf spring, wherein the inner panel middle warp is resilient and can be flattened along the panel overlap when compressed together in an installed mode.

16. The root barrier of claim 13, wherein the inner panel is formed with a flexible panel lower edge.

17. The root barrier of claim 13, wherein the inner panel is configured to deform when a root grows under the inner panel.

18. The root barrier of claim 13, wherein the inner panel is formed of at least 40% low-density polyethylene by weight, 40% high density polyethylene by weight, and at least 2% carbon.

19. The root barrier of claim 13, wherein the inner panel right rib is V-shaped and the panel left rib is also V-shaped.
